(19) United States
(12) Patent Application Publication
(10) Pub. No.: US 2005/0069749 A1
(43) Pub. Date: Mar. 31, 2005

(54) Flow field plate arrangement

(76) Inventors: David Frank, Scarborough (CA); Nathaniel Ian Joos, Toronto (CA); Xuesong Chen, Brampton (CA); Sonia Sorbera, Mississauga (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/917,518

(22) Filed: Aug. 13, 2004

Related U.S. Application Data
(60) Provisional application No. 60/495,092, filed on Aug. 15, 2003.

(51) Int. Cl. H01M 8/02; H01M 8/04; H01M 2/08

(52) U.S. Cl. 429/38; 429/26; 429/35

(57) ABSTRACT

Aspects of some embodiments of the present invention provide flow field plates that have been designed to potentially reduce the unit cost of each flow field plate employed in an electrochemical cell stack. Thus, for some embodiments of the present invention an electrochemical cell includes a number of flow field plates each having a number of manifold apertures that all have the same area. A first one of the manifold apertures is used for a first process gas/fluid and a second one of the manifold apertures is used for a second process gas/fluid. The manifold apertures on the flow field plates align to form elongate channels that extend through the electrochemical cell as described in more detail herein.

### PRIORITY CLAIMS

This application claims the benefit under 35 USC 119(e) of U.S. Provisional Application No. 60/495,092, which was filed on Aug. 15, 2003, and the entire contents of which is hereby incorporated by reference.

### FIELD OF THE INVENTION

The present invention relates to electrochemical cells, and, in particular to various arrangements of flow field plates suited for use therein.

### BACKGROUND OF THE INVENTION

An electrochemical cell, as defined herein, is an electrochemical reactor that may be configured as either a fuel cell or an electrolyzer cell. Generally, electrochemical cells of both varieties include an anode electrode, a cathode electrode and an electrolyte layer (e.g. a Proton Exchange Membrane) arranged between the anode and cathode electrodes. The anode and cathode electrodes are commonly provided in the form of flow field plates. Hereinafter it is to be understood that the designations “front surface” and “rear surface”, of flow field plates, indicate the orientation of a particular flow field plate with respect to the electrolyte layer. The “front surface” refers to an active surface facing an electrolyte layer, whereas, the “rear surface” refers to a non-active surface facing away from the electrolyte layer.

Process gases/fluids (reactants and products) are supplied to and evacuated from the vicinity of the electrolyte layer through a flow field structure arranged on the front surface of a particular flow field plate. The flow field structure typically includes a number of open-faced channels referred to as flow field channels that are arranged to spread process gases/fluids over the electrolyte layer.

Each flow field plate also includes a number of manifold apertures. Each manifold aperture is provided to serve as a portion of an elongate distribution channel for one of fuel, oxidant, coolant and exhaust process gases/fluids. When an electrochemical cell stack is assembled, the respective manifold apertures of the constituent flow field plates, align to form elongate distribution channels extending through the stack.

The various process gases/fluids, employed and produced within a particular electrochemical cell, typically have different stoichiometries relative to one another. Thus, in order to optimize the performance of an electrochemical cell each respective manifold aperture provided on the flow field plates for a corresponding process gas/fluid is sized so that each process gas/fluid is supplied or evacuated in a manner relative to its stoichiometry.

For example, with respect to hydrogen-powered fuel cells, two hydrogen molecules are consumed for each oxygen molecule consumed. This requires more hydrogen to flow over a respective anode flow field plate than a corresponding stoichiometric amount of oxygen flowing over a corresponding cathode flow field plate. This is achieved by making the input and output manifold apertures for the hydrogen larger than those for the oxidant.

However, if air is used as the source of oxygen the aforementioned relative sizing is reversed. Air is only about 20% oxygen and so more air is needed to provide the required stiochiometric amount of oxygen than if pure oxygen is supplied. Accordingly, inlet and outlet manifold apertures for the oxidant are made larger than those for the hydrogen fuel.

In another example, with respect to water supplied electrolyzers, two hydrogen molecules (H₂) are produced for each oxygen (O₂) molecule produced. This results in more hydrogen flowing over a respective cathode flow field plate than a corresponding stoichiometric amount of oxygen flowing over a corresponding anode flow field plate. Typically, flow field plates adapted for use in electrolyzers have input and output manifold apertures for the hydrogen that are larger than those for the oxidant; and additionally, the widths of the flow field channels on the cathode flow field plate are made wider than the widths of the flow field channels on the anode flow field plate to accommodate the relatively larger volume of hydrogen on the cathode side of the electrolyte layer.

A consequence of having different flow field structures (for the anode and the cathode) is that the ribs that define the flow field structure on an anode flow field plate are often offset with those on a corresponding cathode flow field plate. Shearing forces caused by the offset may damage an electrolyte membrane arranged between the flow field plates. The offset between the flow field plates may, in some specific instances, also impede the distribution of process gases/fluids within an electrochemical cell, thereby reducing efficiency. Moreover, the differences make the manufacturing and assembly of flow field plates complicated and costly.

Various designs for flow field structures are known. A commonly known serpentine-shaped flow field structure is disclosed in U.S. Pat. Nos. 4,988,583, 6,099,984 and 6,309,773. Such a serpentine-shaped flow field structure provides a long flow channel within a compact area. However, it is difficult to control the flow, pressure and temperature of the process gases/fluids across a flow field plate that employs this structure. This structure also provides more places for water and contaminants to accumulate, increasing the risk of flooding or poisoning an electrochemical cell.

### SUMMARY OF THE INVENTION

According to an aspect of an embodiment of the invention there is provided a flow field plate suited for use in an electrochemical cell including a first manifold aperture for a first process gas/fluid; and a second manifold aperture for a second process gas/fluid; wherein the first and second manifold apertures have substantially the same area.

In some embodiments a flow field plate includes first and second corners, wherein the first and second manifold apertures are arranged near the first and second corners respectively, and wherein the shape of the first and second manifold apertures is adapted to distribute mechanical stress near the first and second corners, respectively.

In some embodiments a flow field plate also includes a third manifold aperture for the first process gas/fluid; and, a fourth manifold aperture for the second process gas/fluid; wherein the third and fourth manifold apertures have substantially the same area. In some related embodiments, the first and third manifold apertures have substantially the same area. In some related embodiments, the first and third manifold apertures have the same dimensions.

According to another aspect of an embodiment of the invention there is provided a flow field plate suited for use in an electrochemical cell including a plurality of manifold apertures each having the same area, wherein a first one of the manifold apertures is used for a first process gas/fluid and a second one of the manifold apertures is used for a second process gas/fluid. In some embodiments, the plurality of manifold apertures have substantially identical dimensions.

According to another aspect of an embodiment of the invention there is provided an electrochemical cell stack including at least one electrochemical cell, each electrochemical cell including a plurality of flow field plates each including a plurality of manifold apertures; wherein, on each flow field plate, the plurality of manifold apertures have the same area and a first one of the manifold apertures is used for a first process gas/fluid and a second one of the manifold apertures is used for a second process gas/fluid; and wherein some of the flow field plates are employed as an anode and some of the flow field plates are employed as a cathode.

In some embodiments all of the plurality of flow field plates have substantially identical manifold apertures, and wherein the respective manifold apertures on the flow field plates align to form a corresponding plurality of elongate channels that each extend through the electrochemical cell stack. In some related embodiments the arrangement of each of the flow field plates is substantially symmetrical permitting the reversal of flow of process gases/fluids through the electrochemical cell stack, thus causing inlets to become outlets and vice versa.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a simplified schematic drawing of a fuel cell module;

FIG. 2 is an exploded perspective view of a fuel cell module;

FIG. 3A is a schematic drawing of a front surface of an anode flow field plate according aspects of an embodiment of the invention that is suitable for use in the fuel cell module illustrated in FIG. 2;

FIG. 3B is a schematic drawing of a rear surface of the anode flow field plate illustrated in FIG. 3A;

FIG. 3C is an enlarged partial sectional view of the anode flow field plate taken along line A-A in FIG. 3A;

FIG. 3D is an enlarged partial view of a fuel manifold aperture and adjacent parts on the front surface of the anode flow field plate illustrated in FIG. 3A;

FIG. 4A is a schematic drawing of a front surface of a cathode flow field plate according aspects of an embodiment of the invention that is suitable for use in the fuel cell module illustrated in FIG. 2;

FIG. 4B is a schematic drawing of a rear surface of the cathode flow field plate illustrated in FIG. 4A;

FIG. 4C is an enlarged partial sectional view of the cathode flow field plate taken along line B-B in FIG. 4A;

FIG. 4D is an enlarged partial view of an oxidant manifold aperture and adjacent parts on the front surface of the cathode flow field plate illustrated in FIG. 4A;

FIG. 4E is an enlarged partial view of a fuel manifold aperture and adjacent parts on the rear surface of the cathode flow field plate illustrated in FIG. 4B;

FIG. 4F is an enlarged partial view of the coolant manifold aperture and adjacent parts on the rear surface of the cathode flow field plate illustrated in FIG. 4B;

FIG. 4G is an enlarged partial perspective view of the oxidant manifold aperture and adjacent parts on the rear surface of the cathode flow field plate illustrated in FIG. 4B;

FIG. 5A shows a sectional view of a fuel cell according to aspects of an embodiment of the invention; and

FIG. 5B shows a sectional view of a conventional fuel cell.

### DETAILED DESCRIPTION OF THE INVENTION

Aspects of flow field structures and plate arrangements according to examples described in the applicant's co-pending U.S. patent application Ser. No. 10/109,002 (filed 29 Mar. 2002) can be employed to provide reduced shearing forces on a membrane and simplify sealing between flow field plates. The entire contents of the applicant's co-pending U.S. patent application Ser. No. 10/109,002 are hereby incorporated by reference.

As disclosed in the applicant's co-pending U.S. patent application Ser. No. 10/109,002, after assembly, a substantial portion of the anode flow field channels and the cathode flow field channels are disposed directly opposite one another with a membrane arranged between the two electrodes. Accordingly, a substantial portion of the ribs of the anode flow field plate match-up with a corresponding substantial portion of the ribs on the cathode flow field plate. This is described as “rib-to-rib” pattern matching hereinafter.

Aspects of flow field plate arrangements according to examples described in the applicant's co-pending U.S. patent application Ser. No. 09/855,018 (filed 15 May 2001) can also be employed to provide an effective sealing between flow field plates and a membrane arranged between the two electrodes. The entire contents of the applicant's co-pending U.S. patent application Ser. No. 09/855,018 are hereby incorporated by reference.

As disclosed in the applicant's co-pending U.S. patent application Ser. No. 09/855,018, the inlet flow of a particular process gas/fluid from a respective manifold aperture does not take place directly over the front (active) surface of a flow field plate; rather, the process gas/fluid is first guided from the respective manifold aperture over a portion of the rear (passive) surface of the flow field plate and then through a “back-side feed” aperture extending from the rear surface to the front surface. A portion of the front surface defines an active area that is sealingly separated from the respective manifold aperture over the front surface when an electrochemical cell stack is assembled. The portion of the rear surface over which the inlet flow of the process gas/fluid takes place has open-faced gas/fluid flow field channels in fluid communication with the respective manifold aperture. The back-side feed apertures extend from the rear surface to the front surface to provide fluid communication between active area and the open-faced gas/fluid flow field channels that are in fluid communication with the respective manifold aperture. Accordingly, as described in the examples provided in the applicant's co-pending U.S. patent application Ser. No. 09/855,018, a seal between the membrane and the flow field plate can be made in an unbroken path around the periphery of the membrane.

In prior art examples, the seal between the membrane and the active area on the front surface of the flow field plate, which is typically around the periphery of the membrane is broken by the open-faced flow field channels leading up to respective manifold aperture from the active area on the front surface of the flow field plate. By contrast, according to the applicant's aforementioned co-pending application a process gas/fluid is fed to the active area on the front surface through back-side feed apertures from the rear surface of each flow field plate, where a seal is made around the back-side feed apertures and the respective manifold aperture(s). This method of flowing fluids from a rear (passive or non-active) surface to the front (active) surface is referred to as “back-side feed” in the description. Those skilled in the art would appreciate that gases/fluids can be evacuated from the active area on the front surface to the rear surface and then into another respective manifold aperture in a similar manner.

Aspects of flow field plate arrangements according to examples described in the applicant's co-pending U.S. patent application [Attorney Ref: 9351-395] (filed 14 May 2004) can also be employed to provide an effective sealing between flow field plates and a membrane arranged between the two electrodes. The entire contents of the applicant's co-pending U.S. patent application [Attorney Ref: 9351-395] are hereby incorporated by reference.

As also disclosed in the applicant's co-pending U.S. patent application [Attorney Ref: 9351-395], the inlet flow of a particular process gas/fluid from a respective manifold aperture does not take place directly over the front (active) surface of a flow field plate; rather, the process gas/fluid is first guided from the respective manifold aperture over a portion of an oppositely facing complementary active surface, belonging to an adjacent electrochemical cell, and then through a “complementary active-side feed” aperture extending through to the front surface of the flow field plate. According to examples described in the applicant's co-pending U.S. patent application [Attorney Ref: 9351-395] a seal between the membrane and the flow field plate can be made in an unbroken path around the periphery of the membrane, without requiring the flow field plate to have a passive surface, as in the examples described in the applicant's co-pending U.S. patent application Ser. No. 09/855,018.

Aspects of flow field plate arrangements according to examples described in the applicant's co-pending U.S. patent application [Attorney Ref: 9351-395] provide for a symmetrical flow field plate arrangement that enables the use of a single flow field plate design for both anode and cathode flow field plates employed in an electrochemical cell stack. That is, in some embodiments, the anode and cathode flow field plates employed for use in an electrochemical cell stack are substantially identical.

It is commonly understood that in practice a number of electrochemical cells, all of one type, can be arranged in stacks having common features, such as process gas/fluid feeds, drainage, electrical connections and regulation devices. That is, an electrochemical cell module is typically made up of a number of singular electrochemical cells connected in series to form an electrochemical cell stack. The electrochemical cell module also includes a suitable combination of associated structural elements, mechanical systems, hardware, firmware and software that is employed to support the function and operation of the electrochemical cell module. Such items include, without limitation, piping, sensors, regulators, current collectors, seals, insulators and electromechanical controllers.

As noted above, flow field plates typically include a number of manifold apertures, that each serve as a portion of a corresponding elongate distribution channel for a particular process gas/fluid. In some embodiments, the cathode of an electrolyzer cell does not need to be supplied with an input process gas/fluid and only hydrogen gas and water need to be evacuated. In such electrolyzer cells a flow field plate does not require an input manifold aperture for the cathode but does require an output manifold aperture. By contrast, a typical embodiment of a fuel cell makes use of inlet and outlet manifold apertures for both the anode and the cathode. However, a fuel cell can also be operated in a dead-end mode in which process reactants are supplied to the fuel cell but not circulated away from the fuel cell. In such embodiments, only inlet manifold apertures are provided.

There are a number of different electrochemical cell technologies and, in general, this invention is expected to be applicable to all types of electrochemical cells. Very specific example embodiments of the invention have been developed for use with Proton Exchange Membrane (PEM) fuel cells. Other types of fuel cells include, without limitation, Alkaline Fuel Cells (AFC), Direct Methanol Fuel Cells (DMFC), Molten Carbonate Fuel Cells (MCFC), Phosphoric Acid Fuel Cells (PAFC), Solid Oxide Fuel Cells (SOFC) and Regenerative Fuel Cells (RFC). Similarly, other types of electrolyzer cells include, without limitation, Solid Polymer Water Electrolyzer (SPWE).

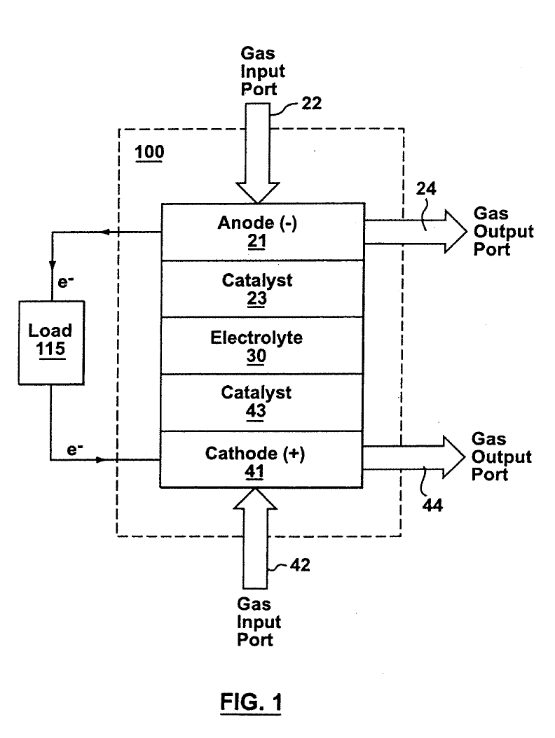

Referring to FIG. 1, shown is a simplified schematic diagram of a Proton Exchange Membrane (PEM) fuel cell module, simply referred to as fuel cell module 100 hereinafter, that is described herein to illustrate some general considerations relating to the operation of electrochemical cell modules. It is to be understood that the present invention is applicable to various configurations of electrochemical cell modules that each include one or more electrochemical cells. Those skilled in the art would appreciate that a PEM electrolyzer module has a similar configuration to the PEM fuel cell module 100 shown in FIG. 1.

The fuel cell module 100 includes an anode electrode 21 and a cathode electrode 41. The anode electrode 21 includes a gas input port 22 and a gas output port 24. Similarly, the cathode electrode 41 includes a gas input port 42 and a gas output port 44. An electrolyte membrane 30 is arranged between the anode electrode 21 and the cathode electrode 41.

The fuel cell module 100 also includes a first catalyst layer 23 between the anode electrode 21 and the electrolyte membrane 30, and a second catalyst layer 43 between the cathode electrode 41 and the electrolyte membrane 30. In some embodiments the first and second catalyst layers 23, 43 are deposited on the anode and cathode electrodes 21, 41, respectively.

A load 115 is coupled between the anode electrode 21 and the cathode electrode 41.

In operation, hydrogen fuel is introduced into the anode electrode 21 via the gas input port 22 under some predetermined conditions. Examples of the predetermined conditions include, without limitation, factors such as flow rate, temperature, pressure, relative humidity and a mixture of the hydrogen with other gases. The hydrogen reacts electrochemically according to reaction (1), given below, in the presence of the electrolyte membrane 30 and the first catalyst layer 23.
H₂→2H⁺+2e⁻ (1)
The chemical products of reaction (1) are hydrogen ions (i.e. cations) and electrons. The hydrogen ions pass through the electrolyte membrane 30 to the cathode electrode 41 while the electrons are drawn through the load 115. Excess hydrogen (sometimes in combination with other gases and/or fluids) is drawn out through the gas output port 24.

Simultaneously an oxidant, such as oxygen in the air, is introduced into the cathode electrode 41 via the gas input port 42 under some predetermined conditions. Examples of the predetermined conditions include, without limitation, factors such as flow rate, temperature, pressure, relative humidity and a mixture of the oxidant with other gases. The excess gases, including unreacted oxidant and the generated water are drawn out of the cathode electrode 41 through the gas output port 44.

The oxidant reacts electrochemically according to reaction (2), given below, in the presence of the electrolyte membrane 30 and the second catalyst layer 43.
½O₂+2H⁺+2e⁻→H₂O (2)

The chemical product of reaction (2) is water. The electrons and the ionized hydrogen atoms, produced by reaction (1) in the anode electrode 21, are electrochemically consumed in reaction (2) in the cathode electrode 41. The electrochemical reactions (1) and (2) are complementary to one another and show that for each oxygen molecule (O₂) that is electrochemically consumed two hydrogen molecules (H₂) are electrochemically consumed.

In a similarly configured water supplied electrolyzer the reactions (2) and (1) are respectively reversed in the anode and cathode. This is accomplished by replacing the load 115 with a voltage source and supplying water to at least one of the two electrodes. The voltage source is used to apply an electric potential that is of an opposite polarity to that shown on the anode and cathode electrodes 21 and 41, respectively, of FIG. 1. The products of such an electrolyzer include hydrogen (H₂) and oxygen (O₂).

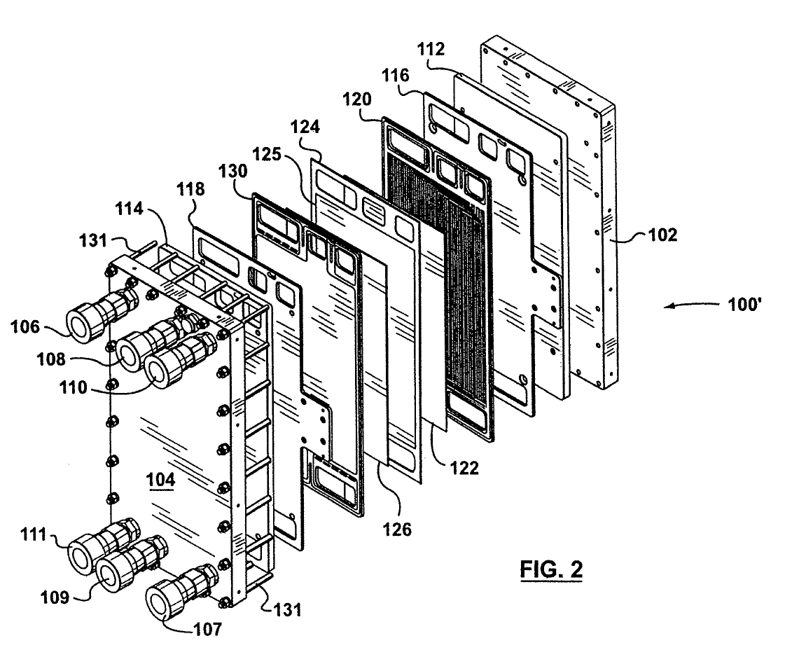

Referring now to FIG. 2, illustrated is an exploded perspective view of a fuel cell module 100′. For the sake of brevity and simplicity, only the elements of one electrochemical cell are shown in FIG. 2. That is, the fuel cell module 100′ includes only one fuel cell; however, a fuel cell stack will usually comprise a number of fuel cells stacked together. The fuel cell of the fuel cell module 100′ comprises an anode flow field plate 120, a cathode flow field plate 130, and a Membrane Electrode Assembly (MEA) 124 arranged between the anode and cathode flow field plates 120, 130. Again, the designations “front surface” and “rear surface” with respect to the anode and cathode flow field plates 120, 130 indicate their respective orientations with respect to the MEA 124. The “front surface” of a flow field plate is the side facing towards the MEA 124, while the “rear surface” faces away from the MEA 124.

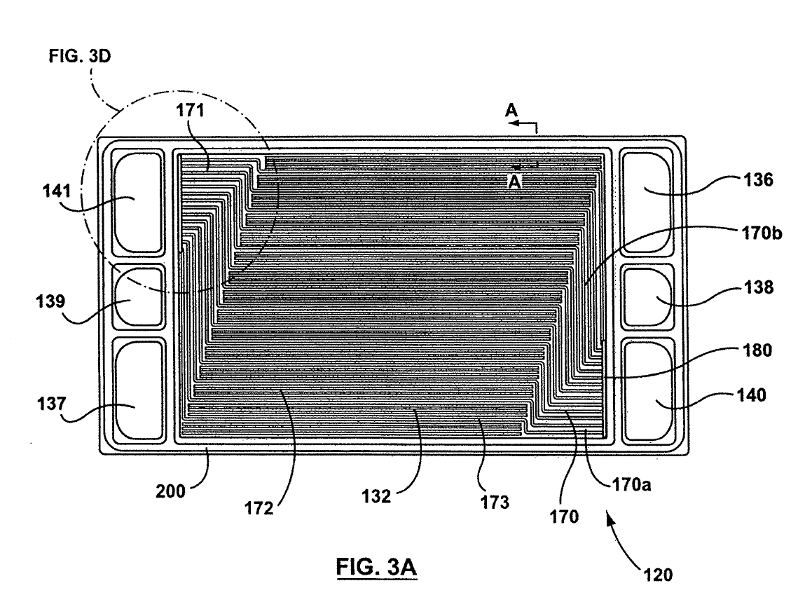

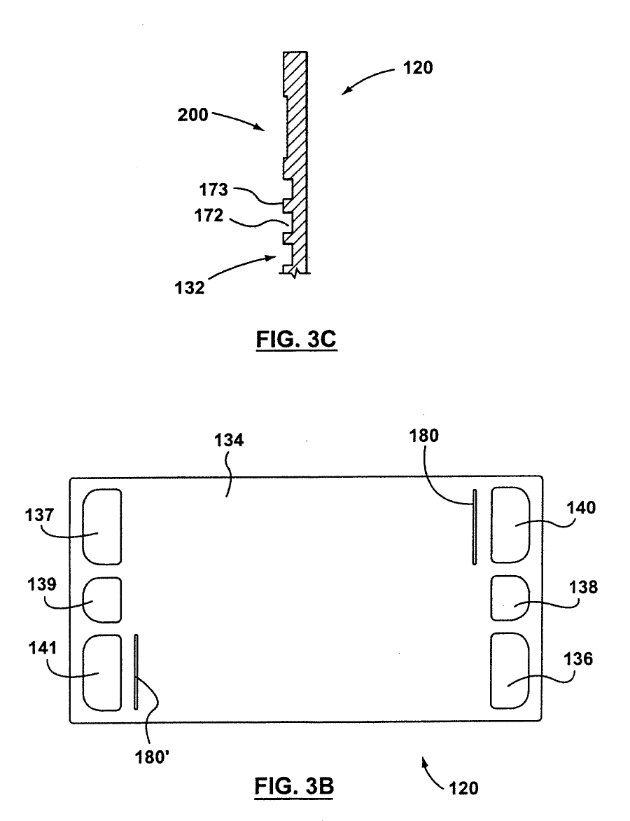

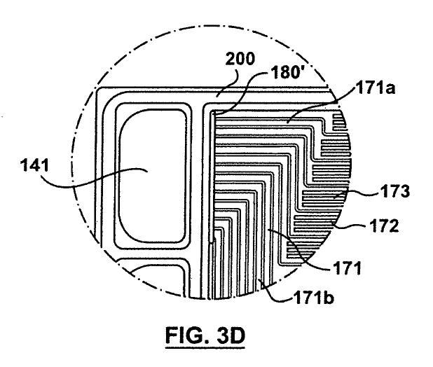

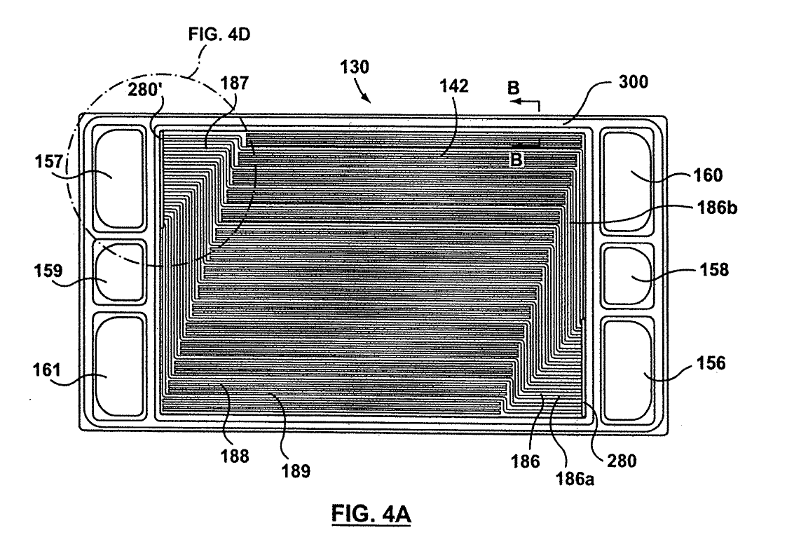

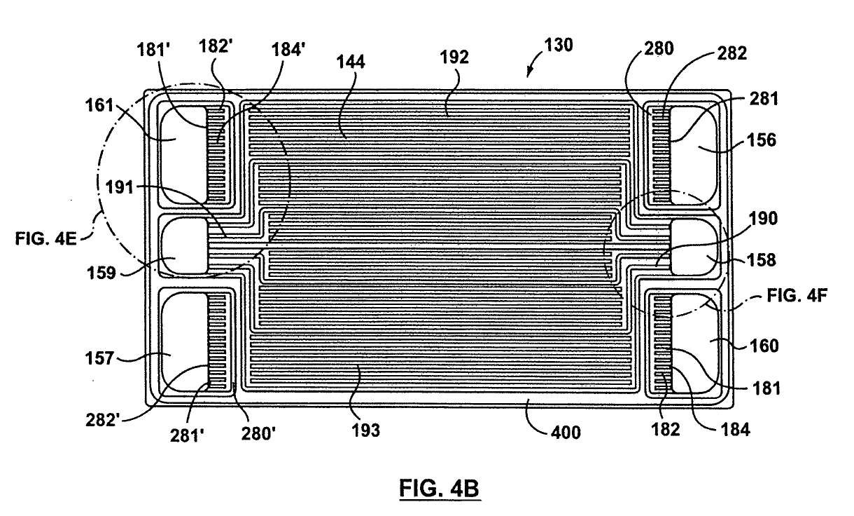

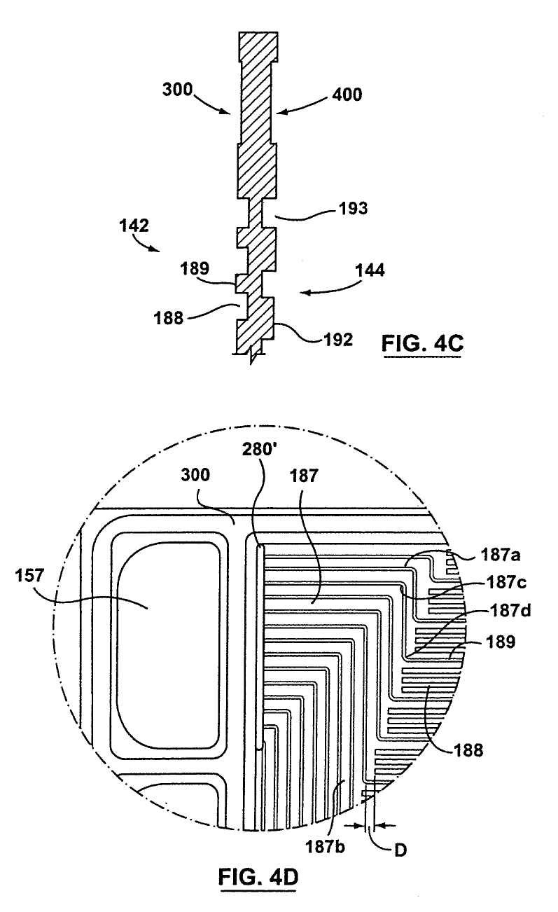

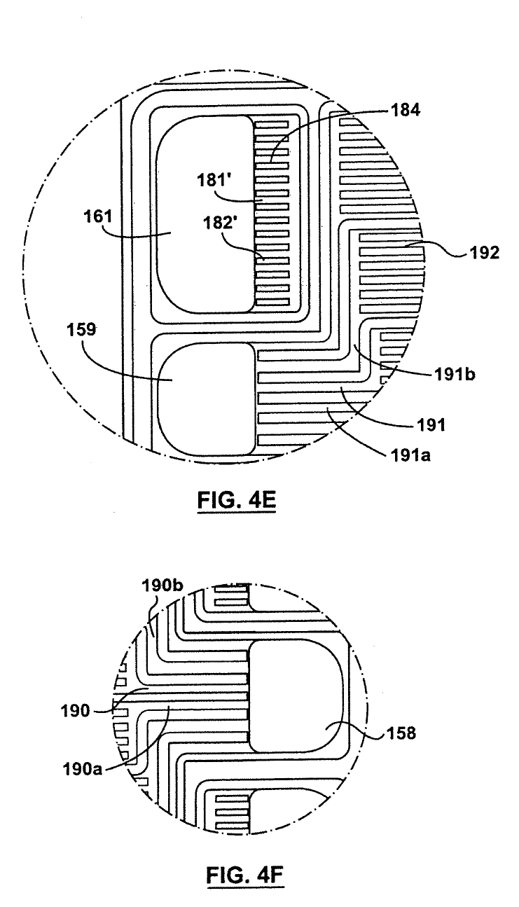

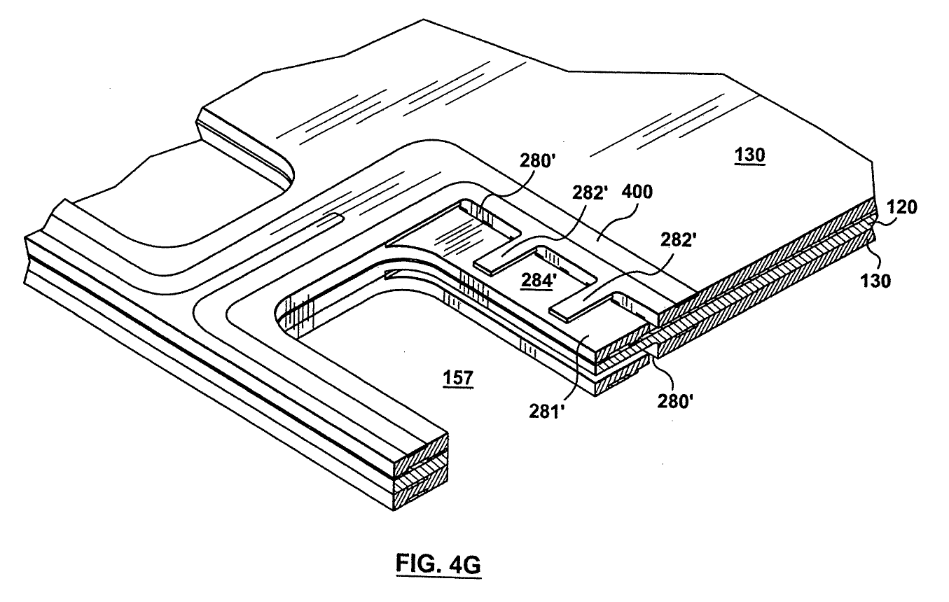

Briefly, each flow field plate 120, 130 has an inlet region and an outlet region. In this particular embodiment, for the sake of clarity, the inlet and outlet regions are placed on opposite ends of each flow field plate, respectively. However, various other arrangements are also possible. Each flow field plate 120, 130 also includes a number of open-faced flow channels that fluidly connect the inlet to the outlet regions and provide a structure for distributing the process gases/fluids to the MEA 124. The anode flow field plate 120 will be described in further detail below with reference to FIGS. 3A-3D and the cathode flow field plate 130 will be described in further detail below with reference to FIGS. 4A-4G.

The MEA 124 includes a solid electrolyte (e.g. a proton exchange membrane) 125 arranged between an anode catalyst layer (not shown) and a cathode catalyst layer (not shown).

The fuel cell of the fuel cell module 100′ includes a first Gas Diffusion Media (GDM) 122 that is arranged between the anode catalyst layer and the anode flow field plate 120, and a second GDM 126 that is arranged between the cathode catalyst layer and the cathode flow field plate 130. The GDMs 122, 126 facilitate the diffusion of the process gases (e.g. fuel, oxidant, etc.) to the catalyst surfaces of the MEA 124. The GDMs 122, 126 also enhance the electrical conductivity between each of the anode and cathode flow field plates 120, 130 and the solid electrolyte 125 (e.g. a proton exchange membrane).

The elements of the fuel cell are enclosed by supporting elements of the fuel cell module 100′. Specifically, the fuel cell module 100′ includes an anode endplate 102 and a cathode endplate 104, between which the fuel cell and other elements are appropriately arranged. In the present embodiment the cathode endplate 104 is provided with connection ports for supply and removal of process gases/fluids. The connection ports will be described in greater detail below.

Other elements arranged between the anode and cathode endplates 102, 104 include an anode insulator plate 112, an anode current collector plate 116, a cathode current collector plate 118 and a cathode insulator plate 114, respectively. In different embodiments varying numbers of electrochemical cells are arranged between the current collector plates 116 and 118. In such embodiments the elements that make up each electrochemical cell are appropriately repeated in sequence to provide an electrochemical cell stack that produces the desired output. In many embodiments a sealing means is provided between plates as required to ensure that process gases/fluids are isolated from one another.

In order to hold the fuel cell module 100′ together tie rods 131 are provided that are screwed into threaded bores in the anode endplate 102 (or otherwise fastened), passing through corresponding plain bores in the cathode endplate 104. Nuts and washers or other fastening means are provided, for tightening the whole assembly and to ensure that the various elements of the individual electrochemical cells are held together.

As noted above various connection ports to an electrochemical cell stack are included to provide a means for supplying and evacuating process gases, fluids, coolants etc. In some embodiments the various connection ports to an electrochemical cell stack are provided in pairs. One of each pair of connection ports is arranged on a cathode endplate (e.g. cathode endplate 104) and the other is appropriately placed on an anode endplate (e.g. anode endplate 102). In other embodiments, the various connection ports are only placed on either the anode or cathode endplate. It will be appreciated by those skilled in the art that various arrangements for the connection ports may be provided in different embodiments of the invention.

With continued reference to FIG. 2, the cathode endplate 104 has first and second air connection ports 106, 107, first and second coolant connection ports 108, 109, and first and second hydrogen connection ports 110, 111. The ports 106-111 are arranged so that they will be in fluid communication with manifold apertures included on the MEA 124, the first and second gas diffusion media 122, 126, the anode and cathode flow field plates 120, 130, the first and second current collector plates 116, 118, and the first and second insulator plates 112, 114. The manifold apertures on all of the aforementioned plates align to form elongate inlet and outlet channels for an oxidant stream, a coolant stream, and a fuel stream. The manifold apertures included on the anode flow field plate 120 and the cathode flow field plate 130 will be described in greater detail below with reference to FIGS. 3A-3D and 4A-4G, respectively.

The fuel cell module 100′ is operable to facilitate a catalyzed reaction once supplied with the appropriate process gases/fluids under the appropriate conditions. In such a catalyzed reaction, a fuel,.such as hydrogen, is oxidized at the anode catalyst layer of the MEA 124 to form protons and electrons. The solid electrolyte (e.g. proton exchange membrane) 125 facilitates migration of the protons from the anode catalyst layer to the cathode catalyst layer. Most of the free electrons will not pass through the solid electrolyte 125, and instead flow through an external circuit (e.g. load 115 in FIG. 1) via the current collector plates 116, 118, thus providing an electrical current. At the cathode catalyst layer of the MEA 124, oxygen reacts with electrons returned from the electrical circuit to form anions. The anions formed at the cathode catalyst layer of the MEA 124 react with the protons that have crossed the solid electrolyte 125 to form liquid water as the reaction product.

Simultaneously, a coolant flow through the fuel cell module 100′ is provided to the fuel cell(s) via connection-ports 108, 109 and coolant manifold apertures in the aforementioned plates. As the fuel cell reaction is exothermic and the reaction rate is sensitive to temperature, the flow through of coolant takes away the heat generated in the fuel cell reaction, preventing the temperature of the fuel cell stack from increasing, thereby regulating the fuel cell reaction at a stable level. The coolant is a gas or fluid that is capable of providing a sufficient heat exchange that will permit cooling of the stack. Examples of known coolants include, without limitation, water, deionized water, oil, ethylene glycol, and propylene glycol.

The front surface of the anode flow field plate 120 is illustrated in FIG. 3A. The anode flow field plate 120 has three inlets near one end thereof, namely an anode air inlet manifold aperture 136, an anode coolant inlet manifold aperture 138, and an anode hydrogen inlet manifold aperture 140, that are arranged thereon to be in fluid communication with the first air connection port 106, the first coolant connection port 108, and the first hydrogen connection port 110, respectively, when a fuel cell module is assembled. The anode flow field plate 120 also has three outlets near the opposite end, namely an anode air outlet manifold aperture 137, an anode coolant outlet manifold aperture 139 and an anode hydrogen outlet manifold aperture 141, that are arranged thereon to be in fluid communication with the second air connection port 107, the second coolant connection port 109, and the second hydrogen connection port 111, respectively, when a fuel cell module is assembled.

In contrast to a conventional design, the anode air inlet and outlet manifold apertures 136, 137 have substantially the same areas as the anode hydrogen inlet and outlet manifold apertures 140, 141, respectively. In some embodiments, the anode air inlet and outlet manifold apertures 136, 137 have substantially the same area as one another as well. The anode coolant inlet and outlet manifold apertures 138, 139 are shown to be smaller than the air and hydrogen inlet and outlet apertures 136, 137, 140 and 141. However, this is not essential and the size of coolant manifold apertures, 138, 139 can be the same as or greater than that of the air and hydrogen inlet and outlet manifold apertures 136, 137, 140 and 141.

Referring to FIGS. 3C and 3D, and with further reference to FIG. 3A, the front surface of the anode flow field plate 120 is provided with a hydrogen flow field 132 that includes a number of open-faced channels. The flow field 132 fluidly connects the anode hydrogen inlet manifold aperture 140 to the anode hydrogen outlet manifold aperture 141. However, hydrogen does not flow directly from the inlet manifold aperture 140 to the flow field 132 on the front surface of the anode flow field plate 120. The present embodiment of the invention advantageously employs “back-side feed” as described in the applicant's co-pending U.S. application Ser. No. 09/855,018 that was incorporated by the reference above. The hydrogen flow between the flow field 132 and inlet manifold aperture 140 and outlet manifold aperture 141, respectively, will be described in more detail below.

A sealing surface 200 is provided around the flow field 132 and the various inlet and outlet manifold apertures to accommodate a seal that is employed for the prevention of leakage and mixing of the process gases/fluids with one another and the coolant. The sealing surface 200 is formed completely enclosing the flow field 132 and the inlet and outlet manifold apertures 136-141. In this particular embodiment, the sealing surface 200 is meant to completely separate the inlet and outlet manifold apertures 136-141 from one another and the flow field 132 on the front surface of the anode flow field plate 120. In some embodiments, the sealing surface 200 may have a varied depth (in the direction perpendicular to the plane of FIG. 3A) and/or width (in the plane of FIG. 3A) at different positions around the anode flow field plate 120.

Slots 180, 180′ are provided adjacent the hydrogen inlet manifold aperture 140 and the hydrogen outlet manifold aperture 141, respectively. The slots 180, 180′ penetrate the thickness of the anode flow field plate 120, thereby providing fluid communication between the front and rear surfaces of the anode flow field plate 120. As is described above with respect to the applicants co-pending U.S. application Ser. No. 09/855,018, the slots 180, 180′ are considered “back-side feed′ apertures. In other embodiments, instead of providing only one slot 180 or 180′, a plurality of slots can be provided adjacent the hydrogen inlet manifold aperture 140 or the hydrogen outlet manifold aperture 141, respectively.

With further reference to FIGS. 3A and 3D, illustrated is one example pattern that can be employed for the hydrogen flow field 132 on the front surface of the anode flow field plate 120. The hydrogen flow field 132 includes a number of fuel inlet distribution flow channels 170 that are in fluid communication with the slot 180. In order to offset and accommodate all of the inlet distribution flow channels 170, each of the inlet distribution flow channels 170 have different longitudinal and transversal extents. Specifically, some of the inlet distribution flow channels 170 have a longer longitudinally extending portion 170a immediately adjacent the slot 180 and have a corresponding shorter transversely extending portion 170b as illustrated in FIG. 3A. Each of the inlet distribution flow channels 170 divides into a number of primary flow channels 172 that are defined by a number of ribs 173. The primary flow channels 172 are straight and extend in parallel along the length of the flow field 132.

At the outlet end of the flow field 132, there is provided a number of fuel outlet collection flow channels 171 that are in fluid communication with the slot 180′. Similar to the inlet distribution flow channels 170, in order to offset and accommodate all of the fuel outlet collection flow channels 171, some of the fuel outlet collection flow channels 171 have a shorter longitudinally extending portion 171a immediately adjacent the slot 180′ and a corresponding longer transversely extending portion 171b, as is illustrated in FIG. 3A. The outlet collection flow channels 171 are positioned in a complementary correspondence with the inlet distribution flow channels 170. The number of primary flow channels 172 divided from each of the inlet distribution flow channels 170 converge into the outlet collection flow channels 171. The number of primary flow channels 172 that is associated with each of the distribution and collection flow channels 170, 171 may or may not be the same. It is not essential that all of the primary flow channels 172 divided from one of the inlet distribution flow channels 170 are connected to a corresponding one of the outlet collection channels. 171, and vice versa.

In preferred embodiments the longitudinally extending portions 170a, 171a of the inlet distribution and outlet collection flow channels 170, 171 are significantly shorter, as compared to the length of the primary flow channels 172. Moreover, the width of the ribs 173 and/or flow channels 172 can be adjusted to obtain different channel to rib ratios. For some embodiments, effort is made to make the primary flow channels almost identical in length so that process gas/fluids traversing a flow field plate experience the same heat exchange history across the surface of the plate. This may, in turn, provide relatively uniform heat distribution over the area of a flow field plate.

The rear surface of the anode flow field plate 120 is illustrated in FIG. 3B. In this particular embodiment, the rear surface of the anode flow field plate 120 is substantially flat and smooth. In other embodiments, the rear surface of the anode flow field plate 120 is not flat and smooth. In such embodiments, the rear surface of the anode flow field plate 120 may have a complimentary design to that of the rear surface of the cathode flow field plate 130 described below with reference to FIG. 4B.

With reference to FIG. 3D, the primary flow channels 172 are spaced from the fuel outlet distribution flow channels 171b. The spacing is preferably 1.5-2 times the width of the primary flow channels 172. Furthermore, the opposite ends of the primary flow channels 172 are also spaced from the fuel outlet collection flow channels 171b and the spacing is preferably 1-2 times the width of the primary flow channels 172. This will be illustrated in more detail below with reference to a portion of the cathode flow field plate 130 illustrated in FIG. 4D.

In operation, hydrogen flows out from the slot 180 into the inlet distribution flow channels 170. After flowing through inlet distribution flow channels 170 the hydrogen flow is further divided into the primary flow channels 172. The hydrogen flows through the primary flow channels 172 and then converges into the outlet collection flow channels 171 at the opposite end of the anode flow field plate 120. The hydrogen flows through the outlet collection flow channels 171, through the slot 180′ to the rear surface of the anode flow field plate 120.

With further reference to FIG. 2, as the hydrogen flows through the channels of the flow field 132, at least a portion of the hydrogen diffuses across the first GDM 122 and reacts at the anode catalyst layer of the MEA 124 to form protons and electrons. The protons then migrate across the membrane 125 towards the cathode catalyst layer. The unreacted hydrogen continues to flow through the channels of the flow field 132, and ultimately exits the anode flow field plate 120 via the anode hydrogen manifold aperture 141 as described above.

The front surface of the cathode flow field plate 130 is illustrated in FIG. 4A. The cathode flow field plate 130 has three inlets near one end thereof, namely a cathode air inlet manifold aperture 156, a cathode coolant inlet manifold aperture 158, and a cathode hydrogen inlet manifold aperture 160, that are arranged to be in fluid communication with the first air connection port 106, the first coolant connection port 108, and the first hydrogen connection port 110, respectively, when a fuel cell module is assembled. The cathode flow field plate 130 has three outlets near the opposite end, namely a cathode air outlet manifold aperture 157, a cathode coolant outlet manifold aperture 159, and a cathode hydrogen outlet manifold aperture 161, that are arranged to be in fluid communication with the second air connection port 107, the second coolant connection port 109, and the second hydrogen connection port 111, respectively, when a fuel cell module is assembled. Although all of the inlets and outlets are arranged at opposite ends of the cathode flow field plate 130, those skilled in the art would appreciate that various other arrangements are possible.

In contrast to conventional design, the cathode air inlet and outlet manifold apertures 156, 157 have substantially the same areas as the cathode hydrogen inlet and outlet manifold apertures 160, 161, respectively. In some embodiments, the inlet and outlet manifold apertures 156, 157 have substantially the same area as one another as well. The cathode coolant inlet and outlet manifold apertures 158, 159 are shown to be smaller than the air and hydrogen inlet and outlet manifold apertures 156, 157, 160 and 161. However, this is not essential and the size of coolant manifold apertures 158, 159 can be the same size as or greater than that of the air and hydrogen inlet and outlet manifold apertures 156, 157, 160 and 161.

Similar to the front surface of the anode flow field plate 120, the front surface of the cathode flow field plate 130 is provided with an oxidant flow field 142 that includes a number of open-faced channels. The flow field 142 fluidly connects the cathode air inlet manifold aperture 156 to the cathode air outlet manifold aperture 157. However, similar to the design of the anode flow field plate 120, air does not flow directly from the inlet manifold aperture 156 to the flow field 142 on the front surface of the cathode flow field plate 130. Rather, air travels from the inlet manifold aperture 157 over a portion of the rear surface of the cathode flow field plate 130 and through the cathode flow field plate out and onto the front surface according to the “back-side feed” concept disclosed the applicant's co-pending U.S. application Ser. No. 09/855,018, that was incorporated by reference above. The details relating to the rear surface of the cathode flow field plate 130 are described in detail below with reference to FIG. 4B.

Also included are slots 280 and 280′ that are respectively provided adjacent the air inlet manifold aperture 156 and the air outlet manifold aperture 157. The slots 280, 280′ penetrate the thickness of the cathode flow field plate 130, thereby fluidly connecting the front and rear surfaces of the cathode flow field plate 130. Each of the slots 280, 280′ is shown as a singular aperture. However, in other embodiments each of slots 280, 280′ can be provided as a set of multiple apertures that extend through the cathode flow field plate 130. With reference to the applicant's co-pending U.S. application Ser. No. 09/855,018, the slots 280, 280′ are otherwise known as “back-side feed” apertures.

The cathode flow field plate 130 is also provided with a sealing surface 300 that is arranged around the flow field 142 and the various inlet and outlet manifold apertures to accommodate a seal for the prevention of leakage and mixing of process gases/fluids with one another and the coolant. Similar to the design of the anode flow field plate 120, the sealing surface 300 may have varied depth and/or width at different positions around the cathode flow field plate 130, as may be desired.

The pattern of the oxidant flow field 142 on the front face of the cathode flow field plate 130 is illustrated in FIGS. 4A and 4D. With further reference to FIGS. 3A and 3D, the oxidant flow field 142 is generally similar to the hydrogen flow field 132. As shown in FIG. 4A, the oxidant flow field 142 includes a number of oxidant inlet distribution flow channels 186 that are in fluid communication with the slot 280. In order to offset and accommodate all of the inlet distribution flow channels 186, each of the inlet distribution flow channels 186 have different longitudinal and transversal extents. Specifically, some of the inlet distribution flow channels 186 have a shorter longitudinally extending portion 186a immediately adjacent the slot 280 and a longer transversely extending portion 186b. Each of the inlet distribution flow channels 186 divides into a number of primary flow channels 188 that are defined by a corresponding number of ribs 189. The primary flow channels 188 are straight and extend in parallel along the length of the flow field 142.

At the outlet end of the cathode flow field plate 130, the oxidant flow field 142 includes a number of oxidant outlet collection flow channels 187 that are provided in fluid communication with the slot 280′. In order to offset and accommodate all of the outlet collection flow channels 187, each of the outlet collection flow channels have different longitudinal and transversal extents. Specifically, some of the outlet collection flow channels 187 have a shorter longitudinally extending portion 187 immediately adjacent the slot 280′ and a longer transversely extending portion 187b. The outlet collection flow channels 187 are positioned in complementary correspondence with the inlet distribution flow channels 186. Accordingly, the primary flow channels 188 divided from each of the inlet distribution flow channels 186 then converge into the outlet collection flow channels 187.

It is to be noted that the longitudinally extending portions of the inlet distribution and outlet collection flow channels 186, 187 are significantly shorter, as compared to the length of the primary flow channels 188. The number of primary flow channels 188 that is associated with each inlet distribution and outlet collection flow channel 186, 187 may or may not be the same. The width of the ribs 189 and/or flow channels 188 can be adjusted to obtain different channel to rib ratios. Similar to the hydrogen flow field 132, it is not essential that all the primary flow channels 188 divided from one of the inlet distribution channels 186 are connected to a particular one of the outlet collection channels 187, and vice versa. For some embodiments, effort is made to make the primary flow channels almost identical in length so that process gas/fluids traversing a flow field plate experience the same heat exchange history across the surface of the plate. This may, in turn, provide relatively uniform heat distribution over the area of a flow field plate.

FIG. 4D shows the enlarged view of oxidant outlet collection flow channels 187a and 187b on the front surface of a cathode flow field plate 130. In this particular example, each of the outlet collection flow channels 187b is divided into four primary flow channels 188 defined by three corresponding ribs 189. Along the longitudinal direction of primary flow channels 188 each of the primary flow channels 188 ends at a position spaced from one of the outlet collection flow channels 187b. In this particular embodiment, the end portions of all primary flow channels 188 are spaced from their corresponding outlet collection channels 187b at substantially the same distance D. This specific arrangement is not necessary and hence each of the primary flow channels may end at a different position with respect to their corresponding outlet collection channels 187b. In this particular embodiment, the distance D between the outlet collection channels 186b and the end portions of the primary flow channels 188 is preferably 1.5-2 times the width of the primary flow channels 188, which may result in a better flow distribution and a reduction in the pressure drop across the cathode flow field plate 130. Similarly, the width of the outlet collection flow channels 187a, 187b is preferably 1-2.0 times that of the primary flow channels 188.

With further reference to FIG. 4D, at each joint between each of the outlet collection flow channels 187a and 187b, a fillet 187c is provided. Similarly, a fillet 187d is provided at each joint between each of the primary flow channels 188 and the outlet collection flow channels 187b. The fillets 187c and 187d help to create a less turbulent flow pattern and hence reduce pressure across the flow field 142. The fillets 187c preferably have a radius of 0.03125 inch (0.79 mm) and the fillets 187d preferably have a radius of 1/64 inch (0.395 mm). With further reference to FIG. 3A, similar fillets can also be provided in fuel inlet distribution flow channels 170 and fuel outlet collection flow channels 171 on the front face of the anode flow field plate 120, as well as in the air inlet distribution flow channels 186 on the front face of the cathode flow field pate 130.

In the foregoing, flow channels for fuel gas, oxidant and coolant have been designated as “primary”, in the sense that such channels will generally be central in a flow field plate and will generally make up the majority of the flow channels provided. The primary flow channels are selected to provide uniform fuel distribution across a surface.

The inlet distribution and outlet collection flow channel configurations included on a flow field plate provides a branching structure where gas flow first passes along one channel (the inlet distribution flow channel) and then branches into a number of smaller channels (the primary flow channels). This structure could include further levels of subdivision. For example, the inlet distribution flow channels could be connected to a number of secondary distribution flow channels that are arranged between the inlet distribution flow channels and the primary flow channels. Similarly, there may be a secondary set of collection flow channels arranged between the primary flow channels and the outlet collection flow channels.

Referring now to FIG. 4B, shown is the rear surface of the cathode flow field plate 130. In this particular embodiment, the rear surface of the cathode flow field plate 130 is provided with a coolant flow field 144 that includes a number of open-faced flow channels. Similar to the front surfaces of the anode and cathode flow field plates 120, 130 a sealing surface 400 is arranged around the coolant flow field 144 and the various inlet and outlet manifold apertures 156-161. As well, the sealing surface 400 may have varied depth and/or width at different positions around the cathode flow field plate 130, as may be desired. However, whereas the sealing surfaces 200, 300 completely separate the inlet and outlet manifold apertures 136-141, 156-161 from the corresponding anode and cathode flow fields 132, 142, respectively, the sealing surface 400 only completely seals the inlet and outlet manifold apertures 156, 157, 160 and 161 (for air and hydrogen) from the coolant flow field 144, permitting coolant to flow between the flow field 144 and the coolant inlet and outlet manifold apertures 158, 159.

That is, the flow field 144 fluidly connects the cathode coolant inlet manifold aperture 158 to the cathode coolant outlet manifold aperture 159. Briefly, in operation, coolant enters the cathode coolant inlet manifold aperture 158, flows along the channels in the flow field 144, and ultimately exits the coolant flow field 144 via the cathode coolant outlet manifold aperture 159. In other embodiments, for example, in air-cooled electromechanical stacks, ambient air is used as the coolant. In such cases and in other embodiments, the coolant flow field 144 can be omitted.

Now referring to FIGS. 4B, 4C and 4E to 4G, the air inlet and outlet manifold apertures 156, 157 have respective aperture extensions 281, 281′ that are arranged on the rear surface of the cathode flow field plate 130.

The aperture extensions 281, 281′ are provided with a respective number of protrusions 282, 282′ extending between the corresponding slots 280, 280′. The protrusions 282, 282′ define a respective number of flow channels 284, 284′ that stop short of the corresponding edges of the air inlet manifold aperture 156 and the air outlet manifold aperture 157, respectively, thereby facilitating air flow between the respective slots 280, 280′ and the corresponding air inlet manifold aperture 156 and the air outlet aperture 157, respectively. The sealing surface 400 completely separates the aperture extensions 281, 281′, and hence the corresponding slots 280, 280′ from the coolant flow field 144 and the other inlet and outlet manifold apertures 158-161.

The cathode hydrogen inlet manifold aperture 160 and outlet manifold aperture 161 also have respective aperture extensions 181, 181′. Similarly, the aperture extensions 181, 181′ are provided with a respective number of protrusions 182, 182′. The protrusions 182, 182′ are arranged on the cathode flow field plate 130 such that they extend between the corresponding slots 180, 180′ of the anode flow field plate 120, when the rear surface of the cathode flow field plate 130 and that of the anode flow field plate 120 abut against each other (once assembled).

The protrusions 182, 182′ define a respective number of flow channels 184, 184′ that stop short of the corresponding edges of the hydrogen inlet manifold aperture 160 and the hydrogen outlet manifold aperture 161, respectively, thereby facilitating hydrogen flow between the slots 180, 18′ and the hydrogen inlet manifold aperture 160 manifold the hydrogen outlet manifold aperture 161, respectively. The sealing surface 400 completely separates the aperture extensions 181, 181′ and hence the respective slots 180, 180′ from the coolant flow field 144 and the other inlet and outlet manifold apertures 156-159.

FIGS. 4B, 4E and 4F show the pattern of the coolant flow field 144 on the rear surface of the cathode flow field plate 130. The coolant flow field includes a number of coolant inlet distribution flow channels 190 that are in fluid communication with the coolant inlet manifold aperture 158. The inlet distribution flow channels 190 have longitudinally extending portions 190a in fluid communication with the coolant inlet manifold aperture 158 and transversely extending portions 190b that extend into the central portion of the coolant flow field 144 to different extents. The inlet distribution flow channels 190 have varied lengths in their longitudinally extending portions 190a in order to accommodate the length of the flow field 144 and one another. Each of the inlet distribution channels 190 divides into a number of primary flow channels 192, defined by a number of ribs 193. The primary flow channels 192 are straight and extend in parallel along the length of the flow field 144. For some embodiments, effort is made to make the primary flow channels almost identical in length so that process gases/fluids traversing a flow field plate experience the same heat exchange history across the surface of the plate. This may, in turn, provide relatively uniform heat distribution over the area of a flow field plate.

The coolant flow field 144 also includes a number of coolant outlet collection flow channels 191 that are in fluid communication with the coolant outlet manifold aperture 159. The outlet collection flow channels 191 have longitudinally extending portions 191a in fluid communication with the coolant outlet manifold aperture 159 and transversely extending portions 191b that extend into the central portion of the coolant flow field 144 to different extents. The coolant outlet collection flow channels 191 have varied lengths in their longitudinally extending portions 191a in order to accommodate the length of the flow field 144 and one another. The primary channels 192 converge into the outlet collection flow channels 191. Moreover, the coolant outlet collection flow channels 191 are positioned in complementary correspondence with the inlet distribution flow channels 190.

In this particular embodiment, the longitudinally extending portions 190a, 191a of the distribution and collection flow channels 190,191 are significantly shorter as compared with the length of the primary flow channels 192. The number of primary flow channels 192 that is divided from each of the inlet distribution channels 190 may or may not be the same. Again, it is not essential that all the primary flow channels 192 divided from each of the inlet distribution channels 190 be connected to a corresponding one of the outlet collection channels 191, and vice versa. Moreover, as may be desired, the width of the ribs 193 and/or flow channels 192 can be adjusted to obtain different channel to rib ratios.

In operation, with reference to FIG. 4A, air flows out from the slot 280 into inlet distribution flow channels 186. Then the air flow in each of the air inlet distribution flow channels 186 is further divided into the primary flow channels 188. After the air flows through the primary flow channels 188 the air converges into the outlet collection flow channels 187. The air then flows through the outlet collection flow channels 187, through the slot 280′ to the rear face of the cathode flow field plate 130. The division of the air flow into the inlet distribution flow channels 186 and then into the primary flow channels 188, with corresponding collection at the outlet end of the cathode flow field pate 130, improves the distribution of the air and achieves a more uniform air distribution across the GDM 126, thereby reducing the pressure differential transversely across the cathode flow field plate 130 and improving fuel cell efficiency.

As air flows through the channels in the flow field 142, at least a portion of the oxygen therein diffuses across the second GDM 126 and reacts at the cathode catalyst layer with the electrons returned from the external circuit to form anions. The anions then react with the protons that have migrated across the MEA 124 to form liquid water and heat. The unreacted air continues to flow along the flow field 142, and ultimately exits the cathode flow field plate 120 via the cathode air outlet 157, as described above.

Simultaneously, with reference to FIG. 4B, coolant flows separately from the coolant inlet aperture 158 into the coolant inlet distribution flow channels 190. The coolant flows into each of the inlet distribution flow channels 190 and is further separated into the primary flow channels 192. Once the coolant flows through the primary flow channels 192 the coolant is collected the outlet collection flow channels 191 at the opposite end of the coolant flow field 144. The coolant then flows through the outlet collection flow channels 191 to the coolant outlet aperture 159. The division of the coolant flow from the inlet distribution flow channels 190 into the primary flow channels 192 improves the distribution of the coolant and achieves more uniform and efficient heat transfer across the flow field 144.

In some embodiments when a fuel cell stack is assembled, the rear surface of an anode flow field plate of one fuel cell abuts against that of a cathode flow field plate of an adjacent fuel cell. The various inlet and outlet manifold apertures are arranged to align with one another to form ducts or elongate channels extending through the fuel cell stack that, at their ends, are fluidly connectable to respective ports included on one or more end-plates.

With reference to FIGS. 3B and 4B, the anode and cathode flow field plates 120, 130 have rear surfaces designed to abut one another. Moreover, on the anode flow field plate 120 and the cathode flow field plate 130, the various manifold apertures 136-141 and 156-161, respectively, align with one another to form six ducts or elongate channels extending through the fuel cell stack that, at their ends, are fluidly connectable to the corresponding ports 106-111.

A seal is arranged between the sealing surface 400 on the rear surface of cathode flow field plate 130 and the smooth rear surface of the anode flow field plate 120 to achieve sealing between the two plates. Subsequently, the hydrogen inlet manifold aperture 160, outlet manifold aperture 161 and the respective aperture extensions 181, 181′ of the cathode flow field plate 130 respectively define two corresponding chambers with distinct portions of the rear surface of the anode flow field plate 120.

In a similar arrangement, the air inlet manifold aperture 156, the outlet manifold aperture 157 and the respective aperture extensions 281, 281′ of the cathode flow field plate 130 respectively define two other chambers with the other distinct portions of the rear surface of the anode flow field plate 120.

With reference to FIGS. 2, 3A and 4A, in operation hydrogen enters through the first hydrogen connection port 110, flows through the duct formed by the anode and cathode hydrogen inlet manifold apertures 140 and 160, and flows to the aforementioned chambers defined by the rear surfaces of the anode and cathode flow field plates 120, 130. For each fuel cell, the hydrogen flows onto the front surface of the anode flow field plates 120, as described above. Once unused hydrogen exits a fuel cell it flows through the duct formed by the anode and cathode hydrogen outlet manifold apertures 141 and 161, and leaves the fuel cell stack through the second hydrogen connection port 111.

Similarly air enters through the first air connection port 106, flows through the duct formed by the anode and cathode air inlet manifold apertures 136 and 156, and flows to the aforementioned chambers defined by the rear surfaces of the anode and cathode flow field plates 120, 130. Then for each fuel cell the air flows onto the front surface of the respective cathode flow field plate 130, as described above. Once air exits a fuel cell it flows through the duct formed by the anode and cathode air inlet manifold apertures 137 and 157, and leaves the fuel cell stack through the second air connection port 107.

In one alternative embodiment, for example, the aperture extensions 181, 181′ and the respective protrusions 182, 182′ are arranged on the rear surface of the anode flow field plate 120, instead of on the rear surface of the cathode flow field plate 130. In such embodiments, the sealing surface 400 on the rear surface of the cathode flow field plate 130 is configured such that it encloses the anode hydrogen inlet manifold aperture 140, the outlet manifold aperture 141 and the associated aperture extensions 181, 181′, the respective protrusions 182, 182′ as well as the corresponding slots 180, 180′.

In other embodiments, the anode and cathode flow field plates are identical. In such embodiments it may be desirable to provide coolant channels on each of the anode and cathode flow field plates half the depth of the coolant channels in the case where only the rear face of the cathode flow field plate 130 is provided with a coolant flow field. This would maintain same amount of space for coolant flow, yet make it possible to make each flow field plate thinner.

As another alternative, the aperture extensions for a particular gas are provided on the rear surface of a flow field plate that requires the particular gas, during operation, on its front surface. With reference to FIGS. 3A and 3B, as an example, the hydrogen inlet and outlet manifold apertures 140, 141 can be provided with respective aperture extensions 181, 181′ (from FIG. 4B) on the rear surface of the anode flow field plate 120. Similarly, for the cathode flow field plate 130, the oxidant inlet and outlet manifold apertures 156, 157 can be provided with respective aperture extensions 281, 281′ on the rear surface thereof, as is already shown in FIG. 4B. In both cases, appropriate slots can be provided in each plate that fluidly connect the front surface of the flow field plate to the rear surface of the flow field plate.

In another alternative embodiment each of the anode and cathode flow field plates is provided with aperture extensions for both the fuel gas flow and the oxidant gas flow. In effect, an extension chamber would then be provided, partly in one of the plates and partly in the other of the plates, extending from the respective manifold aperture, towards slots extending through to the front surface of a flow field plate. This configuration may be desirable where the thickness of each of the flow field plates is reduced.

Moreover, in such a configuration anode flow field plates and cathode flow field plates can be made identical, since according to some embodiments of the present invention, the fuel and oxidant inlet and outlet apertures have the same dimensions, and thus the same area. Specifically, the rear surface of an anode flow field plate is also provided with a coolant flow field in the same pattern as a coolant flow field on the rear surface of a cathode flow field plate.

A sealing surface can also be provided in the same pattern on both flow field plates. If the anode and the cathode flow field plates are identical, as may be the case in some embodiments, a single flow field plate design can be used to make up all the fuel cells of a fuel cell stack. This simplification may in turn lead to a simplification in production steps, which may lead to lower manufacturing costs and shorter assembly times.

The aforementioned also simplifies sealing arrangements since the seal on each plate is the same. Accordingly, in some embodiments, in order to make sure manifold apertures on flow field plates align when a fuel cell stack is assembled, the fuel manifold apertures and oxidant manifold apertures will not only have the same dimension, but they are also symmetrically placed with respect to a virtual axis of the flow field plate, so that when the front surfaces of two identical plates are disposed opposite to each other with a MEA arranged therebetween, the manifold aperture in fluid communication with the flow field on front surface of one plate is aligned with the manifold aperture sealed off from the flow field on the front surface of the other plate. Understandably, the coolant apertures also have to align when the stack is assembled. This also means that the coolant apertures are also symmetrical with respect to the same virtual axis.

A further benefit of the aforementioned arrangement is that the manifold apertures for the process gases/fluids, and even the fluids themselves can be flipped or reversed. There is some indication that significant membrane degradation occurs more rapidly at the inlets to a flow field structure. If the plates, or simply the flow of process gases/fluids, can be reversed or ‘flipped’ so that the inlet manifold apertures become the outlet manifold apertures and vice versa, the life of a membrane (and a stack) may be extended.

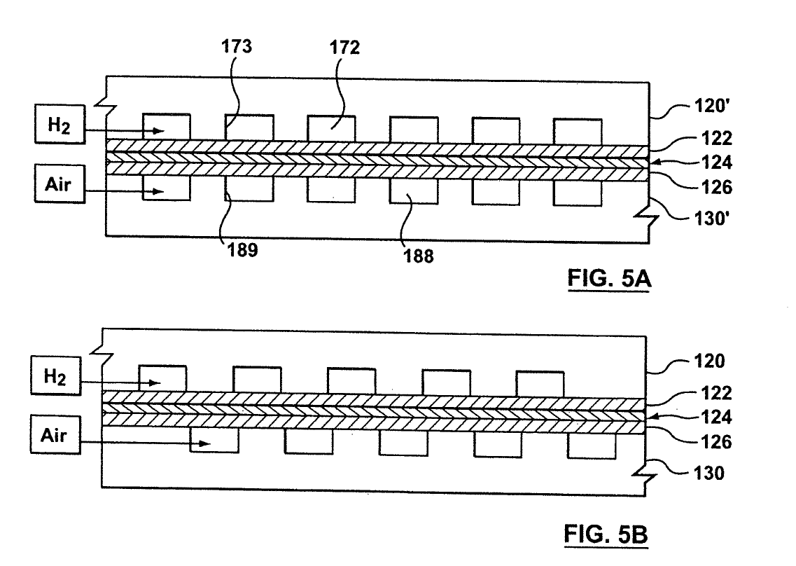

Now referring to FIGS. 5A and 5B, shown are respective sectional views of a single fuel cell according to an embodiment of the present invention and a fuel cell of conventional design. According to some embodiments of the present invention the flow channels of a flow field plate run lengthwise (with respect to the flow field plate), and preferably, the anode and cathode flow field plates have substantially identical configurations. As a consequence to this a substantial number of the ribs 173, 189 on the anode and cathode flow field plates 120, 130 are in alignment. That is the ribs 173 on the anode flow field plate 120 are directly opposed to the ribs 189 on the cathode flow field plate 130 with the MEA 124 arranged in between, as is shown in FIG. 5A.

It is also possible to match part of the inlet distribution flow channels 170 and outlet collection flow channels 171 of the anode flow field plate 120 to the inlet distribution flow channels 186 and outlet distribution flow channels 187 of the cathode flow field plate 130, respectively. Particularly, for embodiments where the anode and cathode flow field plates are identical, transversely extending portions of inlet distribution flow channels and outlet collection flow channels simply match-up when fuel cells are assembled together.

Matching the ribs of anode and cathode flow field plates 120, 130 provides a number of advantages over the conventional non-matching design (shown in FIG. 5B). The GDM and MEA are overcompressed and overstretched due to shearing effects induced by the non-matching ribs. On the other hand, less stress on the GDM and the MEA is expected in fuel cells employing “rib-to-rib” pattern matching. Furthermore, fuel cell performance and efficiency are also expected to improve.

In the present invention, the anode and cathode flow field plates 120 and 130 have the same pattern and the same channel to rib ratio. Preferably, the channel to rib ratio is 1.5:1. However, it is to be noted that a problem may arise when the anode and cathode flow field plates 120 and 130 are identical. From the equations (1) and (2) of the fuel cell reactions, it is to be understood that the stoichiometric ratio of hydrogen to oxygen is 2:1. In practical operation, both fuel and the oxidant gases are supplied to the fuel cell stack in excess flow rate with respect to the reactants consumption rate, and hence the power output of a fuel cell stack to ensure the fuel cell stack has sufficient reactants. This requires more oxidant gas flowing across the cathode flow field 142 than the amount of the fuel gas flowing across the anode flow field 132. Conventionally, this is usually achieved by enlarging the cathode oxidant inlet and outlet apertures 156, 157 and by enlarging the width of cathode flow channels to provide more active areas. In some embodiments of present invention, since the pattern of the flow field and the channel to rib ratio are same and inlet and outlet apertures for fuel and oxidant are substantially identical, the flow field plates are not optimized for stoichiometry. However, as mentioned above, the design of the flow field plates, provided by some embodiments of the invention, may considerably simplify the manufacturing and assembly of fuel cell stacks and may also drastically reduce costs. It is, therefore, justified to make this compromise. Further, it may be possible to alleviate any performance issues adjusting stoichiometries of reactants supplied and/or the conditions under which the reactants are supplied.

In the examples illustrated in FIGS. 3A-3D and 4A-4G, the various manifold apertures are shaped such that they have outside corners with a relatively large radius of curvature. For example, as shown in FIG. 3D, the manifold aperture 141 has an outside corner (i.e., the corner closest to a respective corner of the flow field plate 120) that is substantially dome-shaped (as opposed to rectangular), which distributes the mechanical stress between the outside corner of the manifold aperture 141 and the respective corner of the flow field plate 120 better than a more rectangular corner.

It should be appreciated that the shape of the flow field plates and fuel cell stack of the present invention are not limited to those disclosed in the above description. For example, flow field plates are not necessarily rectangular in shape. A flow field plate may be circular, octagonal, hexagonal, or any other shape desired. Accordingly, the manifold apertures are arranged to take advantage of the shape used for the flow field plate. For example, a circular plate may have manifold apertures that are all the same size, equally and symmetrically arranged around the periphery of the flow field plate. Such an arrangement takes advantage of the uniform and symmetrical shape of a circular flow field plate.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention. Numerous modifications and variations of the present invention are possible in light of the above teachings. It is therefore to be understood that within the scope of the appended claims, the invention may be practiced otherwise than as specifically described herein.

1. A flow field plate suited for use in an electrochemical cell comprising:
a first manifold aperture for a first process gas/fluid; and
a second manifold aperture for a second process gas/fluid;
wherein the first and second manifold apertures have substantially the same area.

2. A flow field plate according to claim 1 further comprising:
a third manifold aperture for the first process gas/fluid; and,
a fourth manifold aperture for the second process gas/fluid;
wherein the third and fourth manifold apertures have substantially the same area.

3. A flow field plate according to claim 2, wherein the first and third manifold apertures have substantially the same area.

4. A flow field plate according to claim 2, wherein the first and third manifold apertures have the same dimensions.

5. A flow field plate according to claim 3, wherein the first and third manifold apertures are at complementary locations on the flow field plate relative to one another.

6. A flow field plate according to claim 3, wherein the second and fourth manifold apertures are at complementary locations on the flow field plate relative to one another.

7. A flow field plate according to claim 1, wherein the first and second manifold apertures have the same dimensions.

8. A flow field plate according to claims 7, wherein the first and second manifold apertures are symmetrical.

9. A flow field plate according to claim 7, wherein the first and second manifold apertures are at complementary locations on the flow field plate relative to one another.

10. A flow field plate according to claim 2 further comprising:
at least one inlet distribution flow channel;
at least one outlet collection flow channel; and
a flow field having a number of primary flow channels that are in fluid communication with said at least one inlet distribution flow channel at one end and in fluid communication with at least one outlet collection flow channel at another end.

11. A flow field plate according to claim 10, wherein each inlet distribution channel is in fluid communication with the first manifold aperture and each outlet collection flow channel is in fluid communication with the third manifold aperture.

12. A flow field plate according to claim 10, wherein the primary flow channels are substantially parallel to one another.

13. A flow field plate according to claim 12, wherein the primary flow channels are all substantially the same length.

14. A flow field plate according to claim 10 further comprising:
a first slot extending through the flow field plate and in fluid communication with each inlet distribution flow channel; and,
a second slot extending through the flow field plate and in fluid communication with each outlet collection flow channel.

15. A flow field plate according to claim 11 further comprising:
a coolant flow field on the rear surface of the flow field plate;
a fifth manifold aperture in fluid communication with the coolant flow field; and
a sixth manifold aperture in fluid communication with the coolant flow field.

16. A flow field plate according to claim 15 further comprising:
a first sealing surface separating the first, second, third, fourth, fifth and sixth manifold apertures from one another and the flow field on the front surface of the flow field plate; and
a second sealing surface separating the first, second, third, fourth manifold apertures from one another and the fifth and sixth manifold apertures and the coolant flow field on the rear surface of the flow field plate.

17. A flow field plate according to claim 1 further comprising first and second corners, wherein the first and second manifold apertures are arranged near the first and second corners respectively, and wherein the shape of the first and second manifold apertures is adapted to distribute mechanical stress near the first and second corners, respectively.

18. A flow field plate suited for use in an electrochemical cell comprising a plurality of manifold apertures each having the same area, wherein a first one of the manifold apertures is used for a first process gas/fluid and a second one of the manifold apertures is used for a second process gas/fluid.

19. A flow field plate according to claim 18, wherein the plurality of manifold apertures have substantially identical dimensions.

20. An electrochemical cell stack including at least one electrochemical cell, each electrochemical cell comprising:
a plurality of flow field plates each including a plurality of manifold apertures;
wherein, on each flow field plate, the plurality of manifold apertures have the same area and a first one of the manifold apertures is used for a first process gas/fluid and a second one of the manifold apertures is used for a second process gas/fluid; and
wherein some of the flow field plates are employed as an anode and some of the flow field plates are employed as a cathode.

21. An electrochemical cell stack according to claim 20, wherein all of the plurality of flow field plates have substantially identical manifold apertures and wherein the respective manifold apertures on the flow field plates align to form a corresponding plurality of elongate channels that each extend through the electrochemical cell stack.

22. An electrochemical cell stack according to claim 21, wherein the arrangement of each of the flow field plates is substantially symmetrical permitting the reversal of flow of process gases/fluids through the electrochemical cell stack, thus causing inlets to become outlets and vice versa.
